(19) United States
(12) Patent Application Publication
(10) Pub. No.: US 2011/0155642 A1
(43) Pub. Date: Jun. 30, 2011

(54) FLUID CATALYTIC CRACKING PROCESS WITH REDUCED CARBON DIOXIDE EMISSION

(75) Inventors: Wilson Kenzo Huziwara, Rio de Janeiro (BR); Leonardo Fialho de Mello, Rio de Janeiro (BR); Oscar Rene Chamberlain Pravia, Rio de Janeiro (BR); Gustavo Torres Moure, Rio de Janeiro (BR); Odnei Cesar Macalossi, Rio Grande (BR); Luiz Carlos Casavechia, Sao Mateus do Sul (BR)

(73) Assignee: PETROLEO BRASILEIRO S.A. - PETROBRAS, Rio de Janeiro (BR)

(21) Appl. No.: 12/980,096

(22) Filed: Dec. 28, 2010

(30) Foreign Application Priority Data
Dec. 28, 2009 (BR) PI 0905257-7

(51) Int. Cl. C10G 11/00; B01J 8/00

(52) U.S. Cl. 208/113; 422/187

(57) ABSTRACT

This invention concerns a fluid catalytic cracking (FCC) process with reduced carbon monoxide emission which modifies the regeneration phase of the spent catalyst by using pure oxygen without the need for dilution when burning coke adhering to the catalyst. In addition, this invention improves the reconditioning stage of the catalyst, incorporating a reconditioner supplementary to a conventional reconditioner which employs nitrogen as a carrier gas in the reconditioning of the already regenerated catalyst.

This application claims foreign priority to Brazilian Patent Application PI 0905257-7, filed Dec. 28, 2009, the contents of which are incorporated herein by reference.

### FIELD OF INVENTION

This invention is directed to a fluid catalytic cracking (FCC) process with reduced CO₂ emission in which the removal of coke from the spent catalyst is made using total combustion process with pure oxygen by employing an innovative route which includes the overall operation of the unit.

### FUNDAMENTALS OF THE INVENTION

FCC units are traditionally considered to be one of the major sources of CO₂ emissions into the atmosphere of a refinery, and as a result, this gas is one of the major causes of the greenhouse effect. The operation and design of these units has been continually improved, with a focus on minimizing the environmental impact caused by CO₂ as much as possible.

The CO₂ emission from FCC units occurs during the phase of the process in which combustion of the coke layer, which forms on the surface of the catalyst, during the regeneration stage of the catalyst in the regenerator, is carried out.

The removal of the layer of coke is necessary as the presence of the coke deactivates the catalyst, and the removal is performed in the regenerator, which may operate under a partial combustion regimen with a CO boiler or total combustion regimen with an energy recovery boiler, using air as a source of oxygen to burn the coke and hence part of the activity of the catalyst is regenerated. During this combustion process, effluent gases are generated which are mostly comprised of nitrogen at a content of approximately 79% to 81% per volume and CO₂ at a content of approximately 12% to 21% per volume, gases which may or may not be expelled into the atmosphere.

The flow of effluent gases from a regenerator that operates on air may be subjected to subsequent processes to recover the CO₂, which generally requires large-scale equipment and considerable energy consumption, precisely due to the abundant presence of nitrogen resulting from the air used in the combustion process. To recover the CO₂ resulting from these flows, in order to be able to reuse or sell this as a finished product with a minimum of 95% per volume of purity making the overall process more economical, it would be necessary to use cryogenic separation techniques or separation processes using molecular sieves, which are extremely expensive or more commonly, separation via absorption of this CO₂ in substances that function as CO₂ absorbents, such as mono and diethanolamine (DEA), to separate the N₂ gas off for other uses or releasing it to the atmosphere.

All the same, even these more common processes mentioned above require copious amounts of energy in addition to large-scale equipment due to the large amount of N₂ present in the gaseous flow that leaves the regenerator at the FCC unit.

By way of comparison with regard to the energy demands mentioned, the latest FCC processes, such as that in this invention, which use pure O₂ (over 95% per volume of purity) in the regeneration phase of the spent catalyst, consume as much as 50% to 60% less energy than the processes which use air because they generate a flow of effluent gases with a CO₂ assay of over 85% per volume. Hence, without the presence of the N₂ in the air, the simple removal of humidity from this flow leads to the purity of the CO₂ to be captured and stored at 95% per volume and far lower energy consumption.

Current FCC units, in addition to seeking to reduce environmental impact, are also having to incorporate a series of improvements to maintain reasonable levels of yield and economy since the lack of good quality petroleum in the world has heralded the need to process increasingly heavier loads and fractions containing high levels of carbon residue which deposits even more coke on the surface of the catalysts as well as containing other contaminants which are hard to process such as: basic nitrogenated, organometallic and sulfated compounds.

Among the problems reported by specialized literature are those associated with the presence of CO₂ in the effluent products of the separator vessel of the converter. These problems occur in the cold area of the unit and in the potential subsequent processes of the flow of cracked products.

The excessive consumption of diethanolamine (DEA) used in the fuel gas treatment systems, which is one of the products generated in the FCC riser, is indicated as one of these problems.

The presence of CO₂ in the effluent products of the separator vessel of the converter also has a negative impact on operation of the Sulfur Recovery Units (SRU) when these are overloaded with CO₂ as this reduces the concentration of effluent acid gas (H₂S) from the recovery of the (DEA) and reduces the yield of the SRU.

The new FCC unit projects also have to overcome the excessive increase in temperature in the regenerators, primarily when operating with pure oxygen.

FCC units work in a heat balance regimen in which heat lost in the cracking reaction is supplied by heat generated in the combustion of the coke deposited on the catalyst.

When the FCC unit receives a heavier oil, the coke formed on the catalyst is greater and the heat generated in the exothermal oxidation reaction of the coke into CO₂ is greater than that required by the endothermic reaction of the cracking, increasing the temperature of the regenerator so that the effluent gases are expelled at a higher temperature. This causes a negative impact and higher energy consumption in order to cool and recover these gases.

Further, very high temperatures lead to fatigue in the construction material of the regenerator. Another problem observed is that high temperatures over 750° C. can deactivate the FCC catalyst.

Another difficulty to be overcome by the new units is how to avoid the presence of vapor in the regenerator. Vapor is known to cause the deactivation of the catalyst and even when not intentionally added it is invariably present, either absorbed in the reconditioned spent catalyst or as a product of the reaction of the combustion of the coke present on the surface of the catalyst. A poorly executed reconditioning operation leads to high vapor content in the regenerator. Vapor enters the regenerator absorbed by the catalyst and the hydrocarbons retained in the cavities of the catalyst are burnt in the regenerator producing water which in turn leads to hydrothermal degradation of the catalyst in the temperature of the regenerator. The situation is all the more serious the higher the temperature of the regenerator.

The influence of flow rates, the appropriate fluidization of the catalyst and catalyst/oil ratio must be considered, which have to be readapted when operating FCC units at unusual and more elevated temperatures. Equipment at FCC units run on a continual cycle and the flow of materials is basically managed and guided via the heat balance between the equipment, however technical literature already presents plausible solution to these problems despite these not yet being entirely as one would wish.

### Associated Techniques

Specialized literature offers a series of teachings associated with this method of FCC unit processing which employs pure oxygen and not air during the regeneration stage of the spent catalyst, with the aim of generating a flow richer in CO₂ which facilitates and economizes the capture of this gas, avoids the emission of this into the atmosphere and also reuses it for subsequent sale as a finished product.

U.S. Pat. No. 4,542,114, for example, explains the operation of a FCC unit regenerator which uses a flow of pure O₂ with the aim of generating a flow of effluents rich in CO₂. To avoid temperature peaks and deficient fluidization of the catalyst inside the regenerator, the invention calculates the use of CO₂ recycling to dilute the flow of O₂ at the intake of the regenerator. This solution requires the use of large-scale equipment and extra energy consumption to reprocess and recycle the amount of CO₂ necessary to adjust the regenerator operation mentioned.

It is recommended that dilution of the oxygen flow be carried out with 70% to 76% CO₂ and it is mentioned that the increased economy of the process of U.S. Pat. No. 4,542,114 is due not only to recovery of the CO₂ but because at the same time the process enables the hydrogen or synthesis gas and sulfur compounds of the flow of effluent gases from the regenerator to also be recovered and subsequently commercialized.

U.S. Pat. No. 5,565,089 explains a FCC catalyst regeneration process similar to that of U.S. Pat. No. 4,542,114 mentioned above, but this is carried out by injecting oxidant gas into the regenerator vessel by using air and as the CO₂ is recovered from the effluent gases, this is recycled and gradually incorporated into the flow of the oxidant gas, along with the air and pure oxygen until at a given condition at which depending on the desired temperature in the regenerator vessel the oxidant gas ends up being converted simply into O₂ diluted with CO₂.

It is worth mentioning that U.S. Pat. No. 4,542,114 and U.S. Pat. No. 5,565,089 discussed above deal solely with improvements incorporated into the processing of the regenerator and with the treatment of the effluent gases of such and make no mention of modifications to the other stages which correspond to the continual cycle of the catalytic fluid cracking process.

Use of an additional reconditioner than that traditionally adopted in FCC units is explained in U.S. Pat. No. 5,601,787 and U.S. Pat. No. 6,162,402. This improvement concerns the need to improve reconditioning of the spent catalyst with the aim of not only of increasing the yield of the unit but also avoiding the recurrent problems caused by the transport of vapor and hydrocarbons towards the regenerator which substantially hinders the operation of this equipment resulting in the accelerated deactivation of the catalysts.

The proposal of in U.S. Pat. No. 5,601,787 and U.S. Pat. No. 6,162,402 mentioned above is to promote a more efficient reconditioning of the spent catalyst, increasing the operating temperature of the spent catalyst reconditioner. This increase in temperature is achieved using a direct heat transfer by introducing a hot regenerated catalyst load into the spent catalyst reconditioner to be processed in a mixture with the spent catalyst.

The improvement in the process is very clear to specialists in the field. In the case of U.S. Pat. No. 5,601,787, equipment configuration is hindered as it enables transport of CO or CO₂ towards the area of the converter separator, which is not recommended as this contaminates the products obtained during catalytic fluid cracking.

Along the same lines, the configuration of the equipment presented in U.S. Pat. No. 6,162,402 may lead to an increase in the generation of CO or CO₂, gases which will be sent directly from the reconditioner to the regenerator.

Other patents, such as for example U.S. Pat. No. 2,451,619, U.S. Pat. No. 3,821,103, U.S. Pat. No. 5,346,613 and U.S. Pat. No. 6,808,621, present specific solutions to tackle the new challenges that FCC units are presented with, but none of these is able at the same time to herald so many improvements in the overall FCC process like the proposal of the invention presented herein which will now be demonstrated below.

### SUMMARY OF INVENTION

Exemplary embodiments of the present invention address the above disadvantages and other disadvantages not described above.

This invention concerns a catalytic fluid cracking process with reduced emission of carbon dioxide and comprises the following stages:
(a) Feeding a load of heavy hydrocarbons and a catalyst load in the primary riser of an FCC unit;
(b) Carry out the catalytic fluid cracking reaction throughout the primary riser of the FCC unit;
(c) Separate at the end of the primary riser of the unit, within the separator vessel of the converter using cyclones, any spent catalyst from the products generated by the catalytic fluid cracking of the load of heavy hydrocarbons;
(d) Feed the spent catalyst originating from the separator vessel of the converter into the reconditioner of the spent catalyst along with a load of regenerated catalyst, which was reconditioned with nitrogen, originating from another reconditioner (a reconditioner of regenerated catalyst), and carry out the reconditioning of this mixture of catalysts using water vapor;
(e) Feed the load of reconditioned catalyst in stage (d) into the riser of the regenerator along with pure oxygen to begin the process of regeneration in the regenerator riser which is to be finalized within the regenerator;
(f) Feed the regenerated catalyst from the regenerator into the reconditioner of the regenerated catalyst and carry out the reconditioning of this using nitrogen;
(g) Feed a part of the catalyst reconditioned with nitrogen into the reconditioner of spent catalyst along with the spent catalyst originating from the separator vessel of the converter and carry out the reconditioning of the mixture of catalyst using water vapor;
(h) Feed a part of the mixture of catalysts reconditioned in stage (g) along with O₂ into the regenerator riser in order to begin the process of regenerating the spent catalyst which is to be finalized above in the regenerator vessel;
(i) Transport another part of the catalyst reconditioned with nitrogen in stage (f) into the primary riser of the FCC unit in order to continue with the continual process of catalytic fluid cracking.

The process of this invention optimizes the overall process of the FCC, practically avoiding the emission of CO₂ into the atmosphere; acting on the regeneration phase of the spent catalyst, which introduces a more effective form of burning the coke adhered to the catalyst and on the reconditioning phase of the catalyst, incorporating a supplementary reconditioner to that used conventionally, which employs nitrogen as a carrier gas in the reconditioning of the already regenerated catalyst.

### BRIEF DESCRIPTION OF THE DRAWINGS

In order for the catalytic fluid cracking process with reduced emission of carbon dioxide, which is the subject of this invention, be better understood and assessed, it will be explained based on the detailed description below, taking the designs referenced below as a basis which comprise an integral part of this report.

FIG. 1 shows a schematic representation of a conventional FCC process.

FIG. 2 shows a schematic representation of the FCC of this invention.

### DETAILED DESCRIPTION OF INVENTION

It is to be understood that both the foregoing general description and the following detailed description are exemplary and are intended to provide further explanation of the invention claimed.

To obtain a better understanding and assessment of the invention, the detailed description of the catalytic fluid cracking process with reduced emission of CO₂ which comprises the subject of this invention, will be referred to in the drawings in accordance with identification of its respective components.

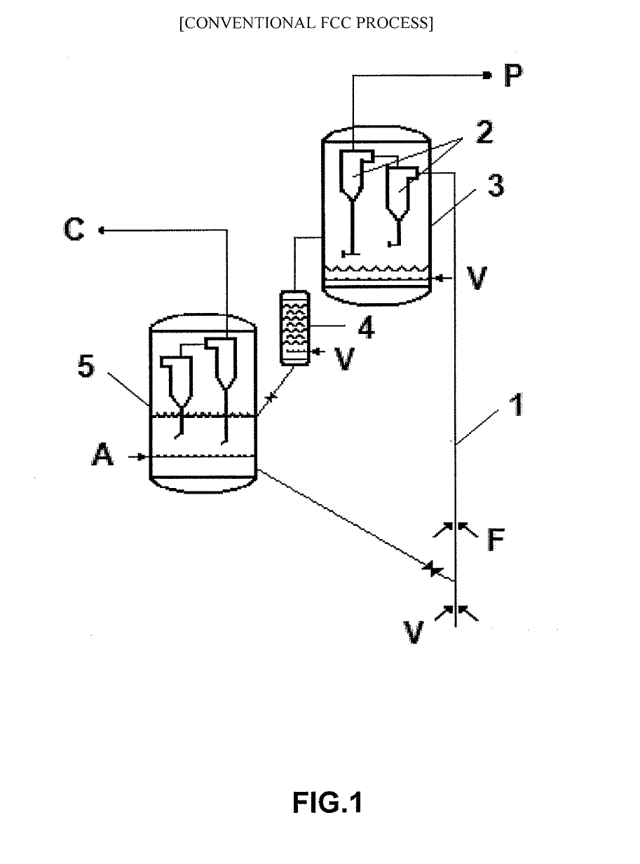

FIG. 1 presents a simplified scheme of a conventional FCC process, in which, compliant with the parameters specified by this, a load of pre-heated heavy hydrocarbons is placed in contact with a load of regenerated catalyst fluidized by vapor and also heated at the base of the riser (1) of the unit to be catalytically cracked.

The cracking reaction takes place while the flow of the load of heavy hydrocarbons (F) and the catalyst ascend the riser (1) and is taken to be completed at the end of the so-called riser (1) when the flow of the load of hydrocarbons already containing the products of the cracking and the spent catalyst, is forced to pass through gas/solid separation cyclones. (2)

The gaseous products of the cracking (P) which come out of the top of the converter separator vessel (3) are separated from the solid particles of the catalyst which in turn flow down the legs of the cyclones and are deposited at the base of the same converter separator vessel (3), from where they are continually transferred to a spent catalyst reconditioner (4). In this spent catalyst reconditioner (4), the catalyst is subjected to a flow of water vapor (V) which seeks to extract any potential traces of hydrocarbons retained in the particles of the catalyst, carrying and redirecting these back towards the converter separator vessel (3). After reconditioning, the catalyst is sent to the regenerator vessel (5) where the catalyst is subjected to high temperatures in the presence of an oxidant gas, normally the oxygen from air (A) to burn the coke which has deposited on the surface during the cracking process in the riser (1).

The catalyst now regenerated recuperates its activity and is then recycled by the riser (1) in order to give continuity to the catalytic fluid cracking process. The combustion gases (c) are removed by the top of the regenerator vessel (5).

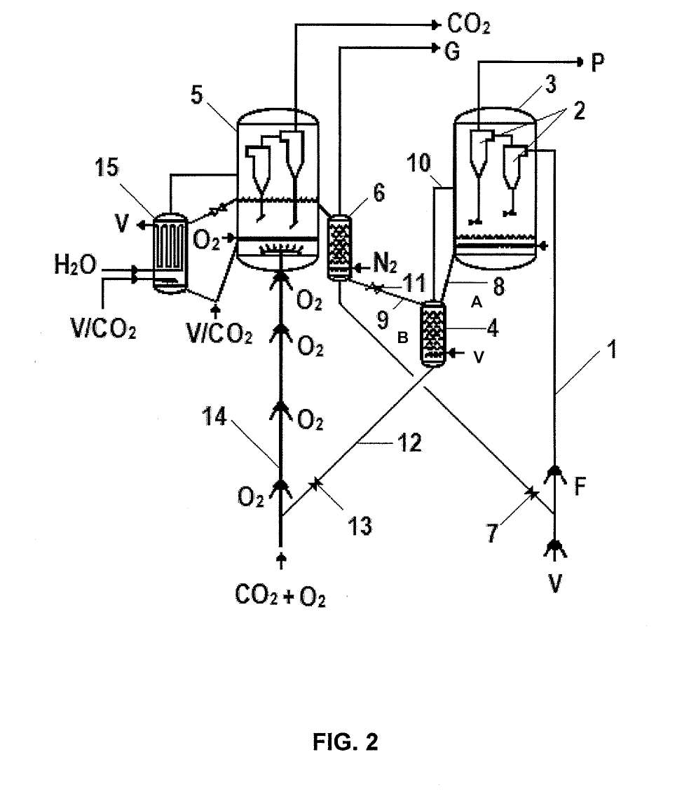

FIG. 2 shows a simplified scheme of the process of this invention, which initially shows that the flowing of the load of regenerated catalyst from the regenerator to the base of the primary riser (1) of the FCC unit is only carried out after the regenerated catalyst has been subjected to reconditioning using nitrogen in a regenerated catalyst reconditioner (6). This modification of the conventional process heralds an improvement in the overall process of the FCC, while the transfer of CO₂ is eliminated by the catalyst flow which is reconditioned to the primary riser (1), reduces consumption of industrial water and also avoids the loss of catalytic activity of the catalyst which occurs during conventional reconditioning with water vapor. The flow of nitrogen (G) which leaves the reconditioner may also come to be used to maintain an inert environment in the tanks of the process.

After regenerated and reconditioned with nitrogen, always in line with the parameters of the process stipulated by the unit project, which are of public knowledge and already fully dominated by specialists in the field, the catalyst is injected into a flow of the load of hydrocarbons rising from the base of the primary riser (1) of the unit along with the load of heavy hydrocarbons (F), in a flow regulated by a primary valve (7) for this mixture of loads to be cracked throughout the so-called primary riser (1).

At the end of the primary riser (1), the cracking reaction is taken to be complete and the flow of the load of hydrocarbons, already containing the gaseous products of the cracking mixed with the solid particles of the spent catalyst, is forced to pass through the gas/solid separation cyclones (2). The gaseous products of the cracking (P) come out of the top of the converter separator vessel (3) and are separated from the solid particles of the spent catalyst which in turn flow down the legs of the cyclones (2) and are deposited at the base of the converter separator vessel (3), from where they are continually transferred to a first spent catalyst reconditioner (4).

The spent catalyst reconditioner (4) simultaneously receives the load of the spent catalyst which comes from the separator vessel of the converter (3), “Load A”, via an initial pipeline (8) that connects the converter (3) to the spent catalyst reconditioner (4) along with the load of the catalyst regenerated and reconditioned by nitrogen in a regenerated catalyst reconditioner (6), “Load B”, via a second pipeline (9) that connects the reconditioner of the regenerated catalyst (6) to the spent catalyst reconditioner (4). Reconditioning of the mixture of the Loads A and B is carried out using a flow of water vapor (V) which seeks to extract and recover any potential traces of hydrocarbons retained in the particles of the catalyst; transporting and redirecting these back towards the separator vessel of the converter (3) via a third pipeline (10) which connects the spent catalyst reconditioner (4) to the separator vessel of the converter (3).

The mixture of the catalyst load regenerated and reconditioned with nitrogen (Load B) which comes from the reconditioner of the regenerated catalyst (6), with the load of spent catalyst which comes from the separator vessel of the converter (3) (Load A), may be carried out at a proportion of 0.1% to 100% in weight of Load A to Load B, preferably, in the range of 50% to 70% in weight of Load A to Load B.

This modified process of reconditioning is more efficient than the traditional one because it manages to perform this operation at higher temperatures than those attained in conventional equipment. Depending on the flow of Load B, which is regulated by a secondary valve (11), the mixture of Loads A and B to be processed within a spent catalyst reconditioner (4) may be at a temperature of 50° C. to 100° C. above the temperatures at which these types of conventional reconditioners operate (e.g., conventional reconditioners typically operate at temperatures of 650° C. to 720° C. for conventional processes). Another advantage of the reconditioning process of this invention is that there is substantially no transport of CO or CO₂ towards the separator vessel of the converter (3) as occurs in the flow technical state.

Via a fourth pipeline (12) which connects the primary spent catalyst reconditioner (4) to the “riser” of the regenerator (14) and with flow regulated by a third valve (13), the load of the catalyst reconditioned in the spent catalyst reconditioner (4) is then directed towards the base of the regenerator riser (14) where the first injection of pure oxygen is also made, and CO₂ may also be added to help facilitate drainage and mixture of catalyst and oxygen; and where combustion of the coke deposited on the referred spent catalyst begins, which is processed throughout the entire length of the regenerator riser (14) and ends up within the regenerator vessel (5).

The temperature of the catalyst load originating from the spent catalyst reconditioner (4) obtained via the mixture with the hot catalyst coming from the reconditioner of the regenerated catalyst (6) ensures that combustion of the coke present in this occurs as soon as this load enters into contact with the pure oxygen. However, to ensure that combustion is maintained under control throughout the ascending extent of the regenerator riser (14), new injections of oxygen can be made throughout the referred riser (14) at one or more additional positions.

Depending on the conditions of the project at the unit which must control the height and diameter of the regenerator riser (14), at least three new injections of pure oxygen gas may be required (as shown in FIG. 2), each at one-third of the way up the referred riser, to control the temperature throughout this and avoid the occurrence of hot spots when the oxygen enters throughout the regenerator riser (14). However, the number and placement of the pure oxygen injection points is variable based on the desired process conditions. Use of pure oxygen in the regeneration phase of the catalyst particularly raises the temperature inside the regeneration vessel (5) as well as presenting the risk of a peak in this temperature and insufficient fluidization of the catalyst within the regenerator vessel (5). These problems are wholly corrected by the innovative use of this regenerator riser (14) which along with the catalyst cooler (15) is able to control the regeneration temperature and avoid the deactivation of the catalyst which tends to occur at a temperature close to 720° C. The catalyst cooler is a heat exchanger device type hull and tube. The catalyst warm from the regenerator (11) enters on the top of the catalyst cooler, and runs out cold after heat exchange, by the bottom, and goes back to the regenerator (11). The catalyst remains continuously fluidized by injecting a fluid at the bottom of the cooler catalyst. In the specific case of the present invention, the fluid used to fluidize the catalyst is carbon dioxide, CO₂ or water vapor, preferably CO₂.

Operation of the regenerator vessel (5) performed in the manner extolled by this invention enables use of a density in the range of 85 kg to 95 kg of catalyst/m³ of oxygen, which makes the combustion of the coke present on the surface of the catalyst even more efficient.

By way of comparison, the regenerator risers mentioned in literature, which only operate on air, present low effectiveness at eliminating coke because they can only work with densities of the order of 24 kg of catalyst/m³ of oxygen, precisely due to the presence of a great concentration of nitrogen (81%) in gas used in the regenerator.

Use of pure oxygen in the regenerator riser (5) also enables combustion of the coke at the base of the regenerator, which has a typical operating temperatures of 650° C. to 720° C. when air is used, to take place at temperatures of around 50° C. to 150° C. lower than when air is used. This fact enables the combustion of coke to occur already at the typical temperatures at which spent catalysts leave the reconditioners.

Two other additional advantages relating to use of oxygen in the catalyst regeneration phase are: the possibility of designing smaller sized regenerator vessels, due to the reduced time catalysts spend inside the referred regeneration vessels and the reduction of the emissions of particles into the atmosphere, around 20% in mass from the top of the regenerator vessel (5), as a result of the lower flow of gas required to carry out combustion of the coke.

This invention also enables the FCC unit to operate with catalyst circulations limited solely by the thermal balance between the flows, as long as a “side-by-side” configuration is adopted. In other words, the regenerator vessel (5) and the separator vessel of the converter (3) are located at the same height to avoid restrictions on the balance of pressure that the difference in level between the two vessels mentioned usually causes.

Finally, it is worth emphasizing that the feasibility of using pure oxygen in the regeneration phase of the catalyst by this invention, presents a considerable advance on the processing technique at FCC units, because it practically eliminates the emission of CO₂ into the atmosphere and also recuperates this as a commercial product, consuming much less energy than the processes of the current technique employed.

### Example

Hereinafter, the present invention will be further specifically described with examples. However, the present invention is not limited to these examples.

The example below seeks merely to illustrate how effective the operation of the catalyst regeneration phase is, the major part of this invention, without however, being considered a limiting factor of its overall content. Regeneration of a catalyst, typical of the FCC process, containing a coke content situated in the range of between 0.7% and 2% in weight, was performed using an oxidant gas containing a mixture per volume of 21% O₂ and 79% He, to simulate regeneration carried out with air and compared with another regeneration operated under identical conditions to the former but this time employing pure O₂ as oxidant gas.

The temperature of the reaction was raised linearly at a rate of 10° C. per minute from room temperature up to 1000° C. The results obtained are shown in Table 1.

TABLE 1

| | Maximum coke combustion | |
|---|---|---|
| Condition | temperature (° C.) | CO/CO₂ Ratio |
| Diluted O₂ | 545 | 1.37 |
| Pure O₂ | 430 | 0.64 |

The results obtained indicate that in effect the temperature at which maximum coke combustion of the catalyst occurs using pure O₂ is far lower than the temperature measured for the other condition and that the CO/CO₂ ratio obtained for the “pure O₂ condition” is less than half of the other condition. Therefore, it is evident that the “pure O₂ condition” generates a flow far richer in CO₂ than the other condition and as a result it is easier to isolate the referred gas, with no major need for energy consumption.

The present invention is susceptible to various modifications and alternative means, and specific examples thereof have been shown by way of example as described in detail. It should be understood, however, that the present invention is not to be limited to the particular devices or methods disclosed, but to the contrary, the present invention is to cover all modifications, equivalents, and alternatives falling within the spirit and scope of the claims.

1-3. (canceled)

4. A process for catalytic fluid cracking with reduced emission of carbon dioxide, comprising initial stages of:
(a) feeding a load of heavy hydrocarbons (F) and a catalyst load into a primary riser (1) of an FCC unit;
(b) carrying out catalytic fluid cracking of the load of heavy hydrocarbons (F) throughout the primary riser (1) of the FCC unit to generate products (P) and spent catalyst;
(c) separating at the end of the primary riser of the unit, within a separator vessel of a converter (3) using cyclones (2), the spent catalyst from the products (P);
(d) feeding the spent catalyst from the separator vessel of the converter (3) (load A) into a reconditioner of spent catalyst (4) along with a load of catalyst regenerated and reconditioned with nitrogen originating from a reconditioner of regenerated catalyst (6) (load B) to obtain a mixture of catalysts (loads A+B); and
(e) reconditioning the mixture of catalysts in the reconditioner of spent catalyst (4) using water vapor (V) to obtain reconditioned catalyst;
and including additional stages of:
(f) feeding the load of reconditioned catalyst from stage (e) into a riser of a regenerator (14) along with a feed of pure oxygen (O₂) gas to begin a process of regeneration in the riser of the regenerator (14), the process of regeneration being finalized within a regenerator vessel (5) to obtain regenerated catalyst;
(g) feeding the regenerated catalyst from the regenerator vessel (5) into the reconditioner of regenerated catalyst (6) and reconditioning the regenerated catalyst in the reconditioner of regenerated catalyst (6) using nitrogen to obtain catalyst reconditioned with nitrogen;
(h) feeding a part of the catalyst reconditioned with nitrogen, which becomes the load of catalyst regenerated and reconditioned with nitrogen (load B), into the reconditioner of spent catalyst (4) to carry out the stage (e) reconditioning with water vapor and thereby feed the riser of the regenerator (14) in stage (f);
(i) transporting another part of the catalyst reconditioned with nitrogen into the primary riser (1) of the unit to maintain the continual process of catalytic fluid cracking.

5. The process in accordance with claim 4, wherein the mixture of catalysts (loads A+B) comprises a ratio of 0.1% to 100% in weight of Load A to Load B.

6. The process in accordance with claim 4, wherein the mixture of catalysts (loads A+B) comprises a ratio of 50% to 70% in weight of Load A to Load B.

7. The process in accordance with claim 4, wherein the ratio between the reconditioned catalyst and the pure oxygen gas being fed into the regenerator riser (14) is 10 kg to 50 kg of reconditioned catalyst per cubic meter of pure oxygen gas.

8. The process in accordance with claim 4, further comprising feeding one or more additional feeds of pure oxygen gas into the regenerator riser (14) at one or more points along the length of the regenerator riser (14).

9. A system for continuous catalytic fluid cracking in an FCC unit with reduced emission of carbon dioxide, comprising:
a primary riser (1) receiving a load of heavy hydrocarbons and a load of catalyst reconditioned with nitrogen and outputting a load of products and spent catalyst;
a separator vessel (3) receiving and separating the load of products and spent catalyst;
a reconditioner of spent catalyst (4) receiving a feed of water vapor, a load of spent catalyst from the separator vessel and a load of catalyst reconditioned with nitrogen and outputting a load of reconditioned catalyst;
a reconditioner of regenerated catalysts (6) receiving a feed of nitrogen gas and a load of regenerated catalyst to generate the catalyst reconditioned with nitrogen;
a regenerator riser (14) receiving a first feed of pure oxygen (O₂) gas and the load of reconditioned catalyst and beginning a process of regeneration; and
a regenerator (5) receiving the output of the regenerator riser (14) and outputting the load of regenerated catalyst to the reconditioner of regenerated catalysts (6).

10. The system according to claim 9, further comprising one or more secondary feeds of pure oxygen connected to the regenerator riser (14) at one or more points along the length of the regenerator riser (14).
